(19) United States
(12) Patent Application Publication
(10) Pub. No.: US 2014/0200820 A1
(43) Pub. Date: Jul. 17, 2014

(54) WAVEFIELD EXTRAPOLATION AND IMAGING USING SINGLE- OR MULTI-COMPONENT SEISMIC MEASUREMENTS

(71) Applicant: WESTERNGECO L.L.C., Houston, TX (US)

(72) Inventors: NIZARE EL YADARI, MERSTHAM (GB); YOUSIF IZZELDIN KAMIL, CRAWLEY (GB); MASSIMILIANO VASSALLO, BRIGHTON (GB)

(73) Assignee: WESTERNGECO L.L.C., Houston, TX (US)

(21) Appl. No.: 14/152,795

(22) Filed: Jan. 10, 2014

Related U.S. Application Data
(60) Provisional application No. 61/751,694, filed on Jan. 11, 2013.

(51) Int. Cl. G01V 1/36

(52) U.S. Cl. CPC G01V 1/364
USPC 702/17

(57) ABSTRACT

Described herein are architectures, platforms, computing systems, and methods for mitigating noise in wavefield extrapolation and imaging. In one aspect, a method of wavefield extrapolation is provided that includes receiving data representing at least one measurement of pressure wavefield or particle motion wavefield; modeling the received data as a sum of signal and noise; providing a noise model to components of the received data; and weighting the measured components of the received data to reduce the impact of noise of results of the wavefield extrapolation.

### RELATED APPLICATIONS

This application claims the benefit of U.S. Provisional Patent Application Ser. No. 61/751,694 filed Jan. 11, 2013, which is incorporated herein by reference in its entirety.

### BACKGROUND

Geological surveying has widespread applications such as to locate oil and gas reserves whether on land or offshore. In the old days, the geological surveying is implemented by looking at surface geological formations and using a surveyor's knowledge and experience to determine locations of underground or subsurface structures likely to contain reserves. With this initial determination of location, a test is performed such as, for example, for the presence of oils.

The above procedure is basically a trial and error method, which is inefficient and expensive to implement.

Alternatively, another methodology utilizes seismic imaging. The seismic imaging utilizes sound waves travelling that are reflected off sub-surface structures. The reflected sound waves are then measured to determine, for example, sub-surface structure formations, depth, number of layers, etc. The seismic imaging is further utilized in conjunction with software analysis to provide multi-dimensional images of the sub-surface structures, and increasing the efficiency of geological surveying.

### SUMMARY

The computing systems, methods, processing procedures, techniques and workflows disclosed herein are more efficient and/or effective methods for identifying, isolating, transforming, and/or processing various aspects of seismic signals or other data that is collected from a subsurface region or other multi-dimensional space.

In some embodiments, a method of wavefield extrapolation is provided that includes receiving data representing at least one measurement of pressure wavefield or particle motion wavefield; modeling the received data as a sum of signal and noise; providing a noise model to components of the received data; and weighting the measured components of the received data to reduce the impact of noise of results of the wavefield extrapolation.

In some embodiments, the wavefield extrapolation includes seismic imaging.

In some embodiments, the particle motion wavefield includes at least one directional component of the gradient of the pressure data.

In some embodiments, wherein the received data includes at least one directional component of a particle velocity vector.

In some embodiments, wherein the received data includes at least one directional component of a particle acceleration vector.

In some embodiments, noise is a scalar for pressure and a vector for particle motion.

In some embodiments, wherein the weighting is determined based on generated noise and the received data.

In some embodiments, the noise is generated based on assumed or estimated statistics of the noise.

In some embodiments, further comprising approximating simulated noise as part of the different noise models, to be stochastic processes that are spatially invariant with a source position or receiver position.

In some embodiments, the weights act as scalars or vectors.

In some embodiments, weighting is based on optimization methods that are carried out in different sub-domains of the wavefield extrapolation.

In some embodiments, the optimization is dependent on one or more wavefield extrapolation subdomains.

In some embodiments, the wavefield extrapolation subdomains include a source from a group comprising an image point, a shot, a receiver and frequency.

In some embodiments, the weighting is directly obtained from the received data, wherein the weighting is one or more of preconditioning filter or switches between conventional and wavefield extrapolation.

In some embodiments, a method of mitigating noise in acoustic vector imaging is provided, there the method includes receiving pressure data or particle motion data; determining if frequencies of components of the received pressure data or motion data is greater than threshold values; and directly summing migrated frequencies of the received pressure data or motion data, if the frequencies are greater than the threshold values.

In some embodiments, frequencies of pressure data and gradients of pressure data are summed.

In some embodiments, frequencies that are not greater than related frequencies are deghosted.

In some embodiments, frequencies that are deghosted are migrated and summed with other migrated frequencies.

In some embodiments, further comprising adjusting the threshold values based on migration techniques applied to the pressure data or gradients of the pressure data.

In some embodiments, a computing system is provided that comprises at least one processor, at least one memory, and one or more programs stored in the at least one memory, wherein the programs comprise instructions, which when executed by the at least one processor, are configured to perform any method disclosed herein.

In some embodiments, a computer readable storage medium is provided, which has stored therein one or more programs, the one or more programs comprising instructions, which when executed by a processor, cause the processor to perform any method disclosed herein.

In some embodiments, a computing system is provided that comprises at least one processor, at least one memory, and one or more programs stored in the at least one memory; and means for performing any method disclosed herein.

In some embodiments, an information processing apparatus for use in a computing system is provided, and that includes means for performing any method disclosed herein.

### BRIEF DESCRIPTION OF THE DRAWINGS

For a better understanding of the aforementioned embodiments as well as additional embodiments thereof, reference should be made to the Description of Embodiments below, in conjunction with the following drawings in which like reference numerals refer to corresponding parts throughout the figures.

FIG. 1 illustrates a computing system in accordance with some embodiments.

FIG. 2 illustrates a marine seismic data acquisition system in accordance with some embodiments described herein.

FIG. 3 illustrates a process chart illustrating an example method for mitigating noise in acoustic vector imaging in accordance with some embodiments.

FIG. 4 illustrates a process chart illustrating an example method for mitigating noise in acoustic vector imaging in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

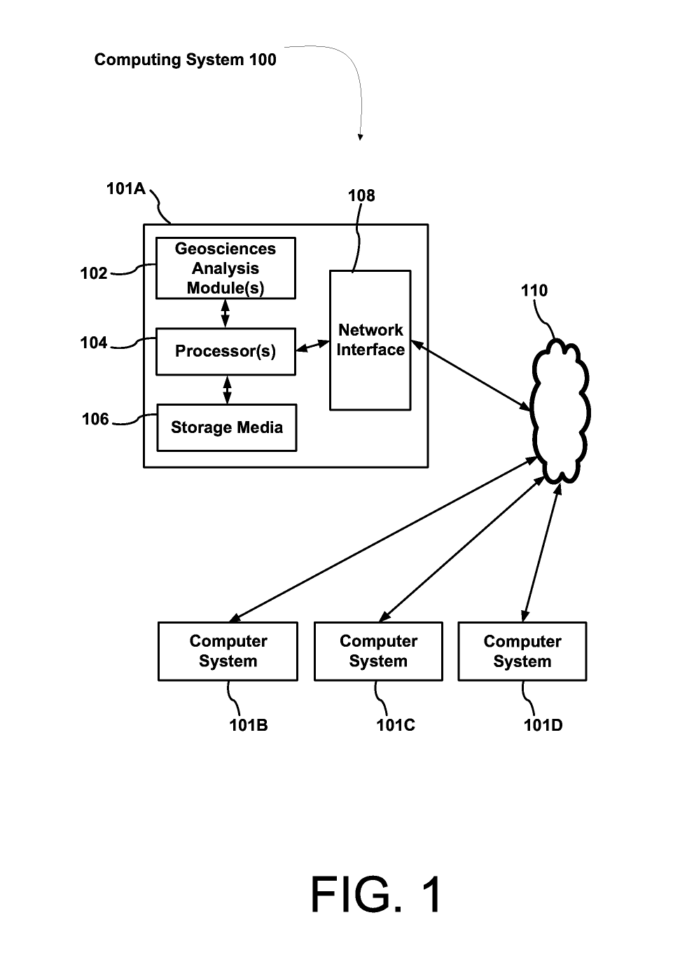

FIG. 1 depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Attention is now directed to architectures, platforms, computing systems, and methods for mitigating noise in vector acoustic imaging. In some embodiments, the mitigation of noise in the processing of pressure data and its gradient components are addressed.

As an example of some implementations described herein, pressure data and its gradient components are measured and recorded at a particular point in time or space. In the case of acoustic medium (e.g., marine seismic), the gradient components of the pressure data are inline-x, crossline-y and vertical-z components of a particle velocity and/or a particle acceleration. For example, an accelerometer sensor (sensor) may acquire seismic data in the crossline direction which represents at a particular point, a partial derivative of a pressure wavefield with respect to a crossline (i.e., “y”) direction, and in the other inline direction accelerometer sensors (sensors) may acquire seismic data representative of the pressure data with respect to an inline (i.e., “x”) direction and so on for the vertical direction. Also, a component of a gradient wavefield may be computed by means of a gradient operator, for example by finite difference, applied to the pressure wavefield. In this example, the acquired seismic data (i.e., pressure data and its gradients) are recorded as traces and they are utilized for further seismic data processing.

The acquired seismic data represented by measured pressure data and its gradient components, provides a total pressure wavefield and its gradient in addition to noise (e.g., instrumental, flow, vibration, torsional noise, etc.). The noise in the pressure and gradient measurements may be identified. Gradient measurement noise may have different statistics as to pressure noise. Therefore, different noise models may be used for the pressure and gradient measurements.

The recorded data may be expressed as sum of noise-free data (i.e., ideal pressure and gradient data) and its corresponding noise component. The resulting noise-added components are subsequently weighted by optimal (or substantially optimal, or improved) solutions in order to provide optimal (or improved) simultaneous removal of noise and ghost effects. The weighting may include different approaches and may be applied for each component as the components may have different noise models, or the weighting may be applied to one or more components. This approach may then mitigate presence of noise in the pressure data and/or one or more gradient components, or in the recorded seismic data in general. Furthermore, this approach provides a higher bandwidth for higher vector acoustic imaging resolution.

In another implementation, the mitigation of noise utilizes a special filtering of the recorded pressure data and/or one or more gradient components. In this implementation, the optimal weighing after the introduction of the estimated noise as discussed above is bypassed. In other words, the mitigation of noise in the pressure data and/or one or more gradient components is simplified to exclude the introduction of the estimated noise model and its respective weight function processing.

For example, a residual noise on a multi-component data reveals that at low frequencies, the particle velocities (i.e., gradients) are noisier than the measured pressure. In this example, any simple single sensor-deghosting method may remove the receiver ghost effect at the low frequency bandwidth. Thus, at the low frequency bandwidth of the pressure spectrum such as, below a certain frequency threshold, the single sensor-deghosting may be implemented. The subsequent results or product of the single sensor-deghosting may then be migrated via any conventional migration method.

On the other hand, the measured pressure and its gradient component that are above the certain frequency threshold may be directly migrated using the vector acoustic imaging technique. In some embodiments, this direct migration using the vector acoustic imaging technique need not involve the weighting as discussed in the first embodiment above.

In some embodiments, the sum of the two migrated volumes resulting from this hybrid approach is then taken to lead to the final image. For example, the results of the conventional migration method and the vector acoustic imaging technique are combined to mitigate the noise during the acoustic vector imaging.

### Seismic Data Acquisition

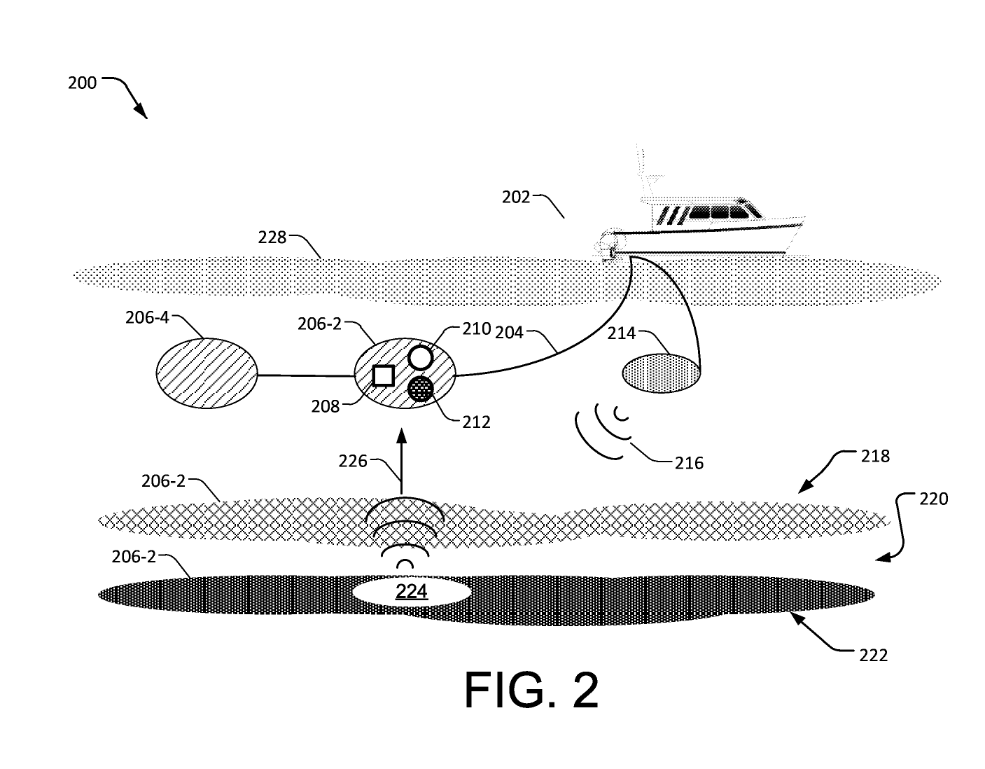

FIG. 2 shows an example scenario 200 that illustrates a marine seismic data acquisition system in accordance with embodiments described herein. Scenario 200 includes, for example, a vessel 202 with towed streamer 204, multi-component seismic sensors 206, a hydrophone 208 for measuring pressure, orthogonally-aligned accelerometers (sensors) 210, pressure gradient sensors 212, and a seismic source 214 (e.g., air guns).

Furthermore, the scenario 200 includes acoustic signal 216 (e.g., shots from air guns) that are directed down towards various subterranean geological formations such as seabed layers 218, 220, 222 and 224. The acoustic signal 216 is reflected, for example, by seabed layer 224 through a reflection signal 226.

In an implementation, the multi-component seismic sensor 206 receives the reflection signal 226, which may be in the form of pressure waves. These pressure waves include “up-going” pressure waves that propagate upwards without reflection to the multi-component seismic sensor 206, as well as “down-going” pressure waves that are produced by reflections of the pressure waves from an air-water boundary 228.

The components within the multi-component seismic sensor 206 (i.e., hydrophone 208, orthogonally-aligned accelerometers 210, and pressure gradient sensors 212) may be utilized to particularly measure pressure wavefield and its gradient components. For example, the gradient components of the pressure wavefield are measured by the pressure gradient sensors 212. In this example, the pressure gradient sensors 212 measure an inline-x, crossline-y and vertical-z components of a particle velocity and/or a particle acceleration at a particular point and direction. In another example, geophones (not shown), particle displacement sensors (not shown), or a combination thereof is utilized to further measure the pressure gradient.

With the measured pressure wavefield and gradient components, data processing tasks such as denoising, deghosting, imaging, etc., is implemented to come up with “noise and ghost” free seismic data. For example, extrapolation and interpolation is utilized to analyze and break down components of the measured pressure wavefield. In this example, the goal of the extrapolation and/or interpolation is to help in building up an image of a survey area for purposes of identifying subterranean geological formations. For example the data processing of the reflection signal 226 is to identify the seabed layer 224.

Although the scenario 200 shows basic components for measuring and detecting multi-component pressure waveforms, its direction of propagation, its velocity, its time derivative or acceleration, etc., other components or devices may be utilized as well to come up with the seismic data that includes pressure data and its gradient components. For example, techniques or mechanisms according to some implementations can be applied in other contexts, such as based on data collected by cables or streamers that are in slanted acquisition profiles (cables or streamers including survey receivers and/or survey sources are slanted rather than horizontal) and/or towed in turning configurations (e.g., data acquired by survey arrangements that shoot in turns or that perform coil-based acquisition).

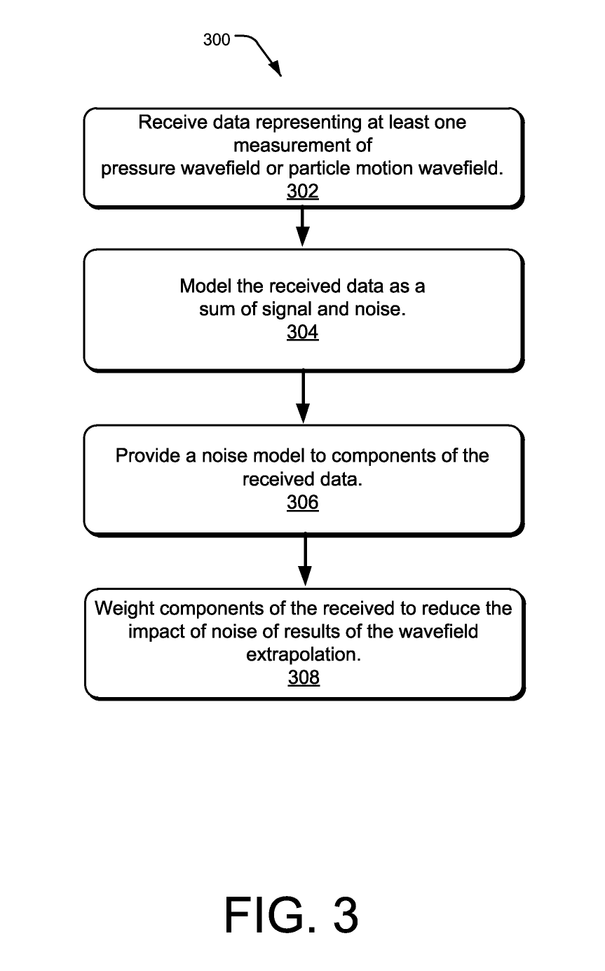

FIG. 3 shows an example process chart 300 illustrating an example embodiment for mitigating noise in wavefield extrapolation. Wavefield extrapolation may include seismic imaging. In this embodiment, conventional formulation may be extended to take into account statistics of the noise models. The order in which the method is described is not intended to be construed as a limitation, and any number of the described method blocks can be combined in any order to implement the method, or alternate methods. Additionally, individual blocks may be deleted from the method without departing from the spirit and scope of the subject matter described herein; moreover, process 300 may be combined or supplemented with other appropriate techniques and methods for processing collected data. Furthermore, the method may be implemented in any suitable hardware, software, firmware or a combination thereof, without departing from the scope of the invention (e.g., computing system 100 as illustrated in FIG. 1).

At block 302, receiving data representing pressure wavefield or particle motion wavfield is performed. For example, a hydrophone 108 measures the pressure wavefield while multi-component seismic sensors 206 measures additional components such as a particle motion vector (e.g., acceleration or velocity). In this example, seismic data processing techniques utilize the benefit of these additional measurements on both synthetic and real data. These techniques, for example, may operate in a pre-stack domain for crossline wavefield reconstruction, two dimension or 2D deghosting, and simultaneous reconstruction and deghosting of a three dimension or 3D full bandwidth wavefield on a fine receiver grid. Particle motion wavefield may include one directional component of a gradient of pressure wavefield data. Data of the particle motion wavefield may include one directional component of a particle velocity vector. Particle motion wavefield data may include a directional component of a particle acceleration vector.

In vector acoustic imaging, these additional measurements may facilitate removal of any adverse effects of the ghost and/or sea-surface reflections. Besides the ability of the vector acoustic migration to remove the receiver ghost in a migration domain, the vector acoustic migration method may also be extended to make use of the receiver ghost. For example, the receiver ghost may be utilized via mirror migration instead of removing it in order to ensure higher data density and improved signal to noise ratio (or other appropriate receiver deghosting techniques).

The extension of the vector acoustic migration method to the mirroring concept is straightforward with the use of multi-component data; however, any noise present at an input multi-component data may directly leak to the imaging results. As further discussed below, further data processing techniques are implemented in some embodiments to mitigate the presence of noise that may leak into the imaging results.

At block 304, the received data of the pressure wavefield or particle motion wavefield are simulated by modeling as sum of signal and noise. A noise with similar statistics may be generated according to assumed or estimated statistics of the noise.

At block 306, different noise models to components of the pressure wavefield and/or particle wavefield are provided. In other words, different noise models may be introduced to different pressure data and gradient components. In particular, noise models are provided to components of data representative of at least one measurement of pressure wavefield or particle motion wavefield. In certain implementations, noise is a scalar for pressure component and a vector for data for particular motion.

In some embodiments, a data equation containing pure pressure data (i.e., no noise) is generated prior to the adding of the noise. Noise that is generated may be assumed or estimated. Furthermore, simulated noise may be part of different noise models which are stochastic processes that are spatially invariant with a source position or receiver position.

For example, to illustrate this process, a conventional imaging condition for migration “I(x)” may be physically thought of as a zero-offset scattered field “P_{S}” for a source and a receiver coinciding at an image point “x.” The image point “x” is evaluated at zero-time (i.e., at time t=0) and forms the equation (1) below:

I(x)=P_{S}(x,x,t=0)=∫_{-∞}^{+∞}P_{S}(x,x,ω)dω (1)

where, “x” is a position at any point in a three-dimensional space by three Cartesian coordinates, while “ω” is an angular frequency. For notation simplicity, variable dependence (e.g., frequency) of variables and operators in the equation (1) and the rest of the equations below is maintained.

Applying Born approximation to cross correlation-type reciprocity theorem for perturbed media may lead to the scattered field “P_{S}” due to a weak perturbation. In terms of down-going P_{D} (i.e., forward) and up-going P_{U} (i.e., backward) wavefield and their spatial gradients ∇xₛP_{D} and ∇xₛP_{U}, respectively, the scattered P_{S} in equation (1) may be expressed as:

$$I ( x ) = {\int }_{- ∞}^{+ ∞} \frac{F ( ω )}{jω} ( \int \int {ρ}^{- 1} ( {x}_{s} ) [ {P}_{D}^{*} ( x , {x}_{s} , ω ) {∇}_{{x}_{s}} {P}_{U} ( x , {x}_{s} , ω ) - {P}_{U} ( x , {x}_{s} , ω ) {∇}_{{x}_{s}} {P}_{D}^{*} ( x , {x}_{s} , ω ) ] . n d {x}_{s} ) . d ω \qquad ( 2 )$$

where “*” denotes a complex conjugate; “j” is imaginary unit; “F(ω)” is related to a source signature that turns the pressure wavefield into impulse responses; “dx_{S}” is a surface containing the sources at x_{S}; “n” is an outward pointing unit normal on “dx_{S};” and “ρ” is a density.

Note that the spatial gradients ∇xₛP_{D} and ∇xₛP_{U} are evaluated at the source positions x_{S}, which implies measurements of data with monopole and dipole sources and receivers. In actual seismic acquisition, the dipole sources are not often deployed. To this end and to overcome this limitation, a far-field approximation to replace the source spatial gradients in P_{S} is implemented as follows:

$${∇}_{{x}_{s}} {P}_{D}^{*} ( x , {x}_{s} , ω ) = \frac{- iω}{V ( {x}_{s} )} {P}_{D}^{*} ( x , {x}_{s} , ω ) \\ and \\ {∇}_{{x}_{s}} {P}_{U} ( x , {x}_{s} , ω ) = \frac{iω}{V ( {x}_{s} )} {P}_{U} ( x , {x}_{s} , ω ) \qquad ( 3 )$$

where “V” is a wave propagation velocity vector.

Modifying the equation (2) with the approximated source spatial gradients as described by the equation (3), and inserting the modified P_{S} into the equation (1) will lead to the conventional cross-correlation imaging condition:

$$I ( x ) = {\int }_{- ∞}^{+ ∞} F ( ω ) ( \int \int \frac{1}{ρ ( {x}_{s} ) V ( {x}_{s} )} {P}_{D}^{*} ( x , {x}_{s} , ω ) {P}_{U} ( x , {x}_{s} , ω ) d {x}_{s} ) d ω \qquad ( 4 )$$

By analogy, with the way how the P_{S} above is formulated, the up-going wavefield (P_{U}) may be obtained by back-propagating the obtained and recorded multi-component data at the receiver locations Xᵣ as follows:

$${P}_{U} ( x , {x}_{s} , ω ) = \frac{1}{jω} \int \int {ρ}^{- 1} ( {x}_{r} ) [ {G}_{U}^{*} ( x , {x}_{r} , ω ) {∇}_{{x}_{r}} P ( {x}_{r} , {x}_{s} , ω ) - P ( {x}_{r} , {x}_{s} , ω ) {∇}_{{x}_{r}} {G}_{U}^{*} ( x , {x}_{r} , ω ) ] n {dx}_{r} \qquad ( 5 )$$

where “G_{U}” is the Green's function that represents the impulse response to a point source located at the receiver position xᵣ. As shown in equation (5), the frequency-domain fields P and ∇xᵣP are the recorded pressure and its spatial gradient obtained in block 302 above.

Note that in marine towed streamer (i.e., OBS or Ocean Bottom Cable acquisitions), measurements of the particle acceleration vector A or the particle velocity vector V are related to the spatial gradient of pressure in acoustic media via the following equation of motion:

∇P(xᵣ,xₛ,ω)=−ρA(xᵣ,xₛ,ω)=jρωV(xᵣ,xₛ,ω) (6)

Also, the component of the gradient wavefield may be computed by means of a gradient operator such as, for example, by finite difference applied to the wavefield itself. Thus, the equation (4) may be rewritten in several imaging subdomains as follows:
(7)

$$\begin{matrix}I ( x ) = \int \int \int {I}_{P} ( x , {x}_{s} , {x}_{r} , ω ) + {I}_{∇ P} ( x , {x}_{s} , {x}_{r} , ω ) d {x}_{r} d ω d {x}_{s} \\ = \int \int {I}_{P} ( x , {x}_{s} , ω ) + {I}_{∇ P} ( x , {x}_{s} , ω ) d ω d {x}_{s} \\ = \int {I}_{P} ( x , {x}_{s} ) + {I}_{∇ P} ( x , {x}_{s} ) d {x}_{s} \\ = {I}_{P} ( x ) + {I}_{∇ P} ( x )\end{matrix}$$

where I_{P/∇P}(•) represents imaging sub-domains steps of the noise free pressure or gradient, respectively.

In general, residual noise is always present on multi-component data even after applying most noise attenuation techniques. This is because the noise behavior is frequency-dependent and changes from one component to another. As such, the step of adding noise to the multi-component data is implemented as a step in the noise mitigation as described herein.

At block 308, weighting components of data representative of at least one measurement of pressure wavefield or particle motion wavefield is performed. This may reduce the noise for the wavefield extrapolation. Weights can be a scalar or a vector. The weighting may be based on different optimization (or improvement) methods that are carried out in different sub-domains of the wavefield extrapolation. Optimization (or improvement) may be dependent on one or more wavefield extrapolation subdomains. Wavefield extrapolation subdomains may include an image point, a shot, a receiver and frequency. In an implementation, weighting is one or more of a preconditioning filter or switches between conventional and wavefield extrapolation.

For example, the up-going wavefield expression of equation (5) is modified by adding the noise components to the pressure and its gradient components denoted by N_{P} and N_{∇P}, respectively. In this example, each component is then weighted by optimal solutions indicated by W_{N}_{_{P}} and W_{N}_{_{∇P}} that minimizes the noise on the final up-going wavefield. Thus, equation (5) may be rewritten as:

(8)

$${\hat{P}}_{U} ( x , {x}_{s} , ω ) = \frac{1}{jω} \int \int {ρ}^{- 1} ( {x}_{r} ) [ {G}_{U}^{*} ( x , {x}_{r} , ω ) {W}_{∇ P} ( {x}_{r} , {x}_{s} , ω ) ⊙ ( {∇}_{{x}_{r}} P ( {x}_{r} , {x}_{s} , ω ) + {N}_{∇ P} ( {x}_{r} , {x}_{s} , ω ) ) - {W}_{P} ( {x}_{r} , {x}_{s} , ω ) ( P ( {x}_{r} , {x}_{s} , ω ) + {N}_{P} ( {x}_{r} , {x}_{s} , ω ) ) {∇}_{{x}_{r}} {G}_{U}^{*} ( x , {x}_{r} , ω ) ] . n d {x}_{r}$$

Unlike N_{P} and W_{P} which are scalar frequency-domain functions, N_{∇P} and W_{∇P} are vectors comprising of (N_{∂P/∂x}, N_{∂P/∂y}, N_{∂P/∂z}) and (W_{∂P/∂x}, W_{∂P/∂y}, W_{∂P/∂z}), respectively. To this end, a Hadamard product is implemented in equation (8) (i.e., denoted by “⊙”). The Hadamard product, for example, conditions equation (8) to the effect that for every component in the multi-component data, different noise model and weighting function are utilized to ensure optimal joint removal of noise and ghost effects.

The statistics of the noise models in equation (8), for example, may be approximated to be stochastic processes that are:
spatially invariant with the source position: N_{P}(xᵣ, ω) and N_{∇P}(xᵣ, ω);
spatially invariant with the receiver position: N_{P}(x_{S}, ω) and N_{∇P}(x_{S}, ω); and
spatially invariant with both source and receiver positions: N_{P}(ω) and N_{∇P}(ω).

For each example stochastic process above, the statistics of the noise models N_{P/∇P} may be estimated from their corresponding recorded data. For example, in order to estimate the noise statistics at different migration subdomains, a realization of the noise (with the same 2^{nd} order statistics) is generated at the prestack domain. Accordingly, the 2^{nd} order statistics at the migration subdomain of interest can be obtained by migrating the generated noise to that subdomain.

By analogy, with regard to equation (7), the modified cross correlation imaging condition that mitigates the noise may be written as:

$$\begin{matrix}\hat{I} ( x ) = \int \int \int {W}_{P} ( x , {x}_{s} , {x}_{r} , ω ) {I}_{{P}_{N}} ( x , {x}_{s} , {x}_{r} , ω ) + \\ {W}_{∇ P} ( x , {x}_{s} , {x}_{r} , ω ) {I}_{∇ {P}_{N}} ( x , {x}_{s} , {x}_{r} , ω ) d {x}_{r} d ω d {x}_{s} \\ = \int \int {W}_{P} ( x , {x}_{s} , ω ) {I}_{{P}_{N}} ( x , {x}_{s} , ω ) + \\ {W}_{∇ P} ( x , {x}_{s} , ω ) {I}_{∇ {P}_{N}} ( x , {x}_{s} , ω ) d ω d {x}_{s} \\ = \int {W}_{P} ( x , {x}_{s} ) {I}_{{P}_{N}} ( x , {x}_{s} ) + {W}_{∇ P} ( x , {x}_{s} ) {I}_{∇ {P}_{N}} ( x , {x}_{s} ) d {x}_{s} \\ = {W}_{P} ( x ) {I}_{{P}_{N}} ( x ) + {W}_{∇ P} ( x ) {I}_{∇ {P}_{N}} ( x )\end{matrix} \qquad ( 9 )$$

where I_{P}_{_{N}}/∇P_{N}(•) represents the imaging of the noisy pressure or the noisy gradient, respectively.

Afterwards, a subsequent step may include estimating of the optimal weights W_{P,∇P} using any type of minimization methods (e.g., the least-squares case). The minimization method may be carried out in the different migration sub-domains. For example, an illustration of the theoretical framework for a single shot image extended domain corresponding to:

Ĵ(x,xₛ)=∫∫W_{P}(x,xₛ,xᵣ,ω)/_{P}_{_{N}}(x,xₛ,ω)+W_{∇P}(x,xₛ,xᵣ,ω)/_{∇P}_{_{N}}(x,xₛ,ω)dxᵣdω (10)

Ĵ(x,xₛ)=∫∫W^{τ}(x,xₛ,xᵣ,ω)Ĵ(x,xᵣ,xₛ,ω)dxᵣdω (11)

with

$$\begin{matrix}\begin{matrix}\underline{I} ( x , {x}_{s} , ω ) = [ \begin{matrix}{I}_{{P}_{N}} ( x , {x}_{r} , {x}_{s} , ω ) \\ {I}_{∇ {P}_{N}} ( x , {x}_{r} , {x}_{s} , ω )\end{matrix} ] \\ = [ \begin{matrix}{I}_{P} ( x , {x}_{r} , {x}_{s} , ω ) \\ {I}_{∇ P} ( x , {x}_{r} , {x}_{s} , ω )\end{matrix} ] + [ \begin{matrix}{I}_{{N}_{P}} ( x , {x}_{r} , {x}_{s} , ω ) \\ {I}_{{N}_{∇ P}} ( x , {x}_{r} , {x}_{s} , ω )\end{matrix} ] \\ = \underline{I} ( x , {x}_{r} , {x}_{s} , ω ) + {\underline{I}}_{N} ( x , {x}_{r} , {x}_{s} , ω )\end{matrix} \\ and & ( 12 ) \\ \underline{W} ( x , {x}_{s} , {x}_{r} , ω ) = [ \begin{matrix}{W}_{P} ( x , {x}_{s} , {x}_{r} , ω ) \\ {W}_{∇ P} ( x , {x}_{s} , {x}_{r} , ω )\end{matrix} ] & ( 13 )\end{matrix}$$

In the above single shot image sub-domain example, using the least square minimization, the optimal weight in the wavefield extrapolation domain is given by:

$$[ {W}_{p} ( x , {x}_{s} , {x}_{r} , ω ) , {W}_{▽ p} ( x , {x}_{s} {x}_{r} , ω ) ] = arg \underbrace{min}_{[ {W}_{p} , {W}_{▽ p} ]} E \{ {‖ \hat{I} ( x , {x}_{s} ) - I ( x , {x}_{s} ) ‖}^{2} \} \qquad ( 14 )$$

The weights in the equations (10) to (14) are dependent on the image point, the shot, the receiver and frequency where the single shot image subdomain is optimized. Depending on the assumed noise model, the data processing is further simplified by dropping the dependency on the receiver position or even the frequency. The minimizer in equation (11) may be expressed as the solution of the following set of normal equation:

W=(Rₙ)⁻¹rᵤ (15)

where R_{ĨĨ} is a covariance matrix and r_{ĨI} is defined as correlation vector between the noisy Ĩ(x, xᵣ, xₛ, ω) and noise free desired I(x, xᵣ, xₛ, ω). This correlation can be directly obtained by utilizing the generated noise 2^{nd} order statistics in the migration subdomain of interest.

The theoretical framework described above may be generalized to any migration sub-domain (e.g., pre-stack data domain, wavefield extrapolation domain, frequency extended image domain, single shot extended image domain, multi-shot image domain, etc.). However, for different domains, the framework may have its own advantages and limitations in terms of quality (signal to noise ratio) and computing efficiency.

Therefore, substituting the weight W in equation (9) leads to an optimal noise-weighted imaging condition that handles the residual noise on every component for every source-receiver trace when it is applied in that comprehensive fashion; those with skill in the art will appreciate that the imaging condition may be applied to a subset of components and/or traces.

It is to be noted that using equation (2) may require acquiring seismic data with multi-component sources and receivers. In other words, the recorded pressure and its three components gradients are excited both by pressure and gradient sources. Equation (4) may require acquiring seismic data with multi-component receivers that are excited at the pressure source.

Furthermore, in some implementations, equation (2) may be used for simultaneously focusing energy from primaries and source & receiver ghost fields leading to removal of any adverse effects of the source or receiver ghost, or sea-surface reflections on the final image. For example, the source ghost effect is handled by combining monopole and dipole source data. In another example, the receiver ghost is integrated while back propagating the recorded multi-component data. In other words, in the case of equation (4) (i.e., absence of dipole sources), the receiver ghost field alone may be focused properly with the energy of the primaries. Any residual energy from the source ghost field may leak into the final image unless source de-ghosting techniques are applied.

As an example of present implementations herein, inserting the optimal weight into imaging equations (2) and (4) provides formulas that are expressed in terms of exact (or substantially exact) Green's functions. In other words, the optimal weight insertion is synthesising and valid for different types of migration whether finite difference based migration or ray based migration is used. As such, the Green's function(s) may be applied in different forms to perform the vector acoustic imaging as described herein.

Furthermore, the noise-weighted imaging equations (2) and (4) may be extended to simultaneously image primary and ghost energies based on the mirror migration concept. This extension leads to mirror vector acoustic migration technique that improves signal to noise ratio in the presence of residual noises.

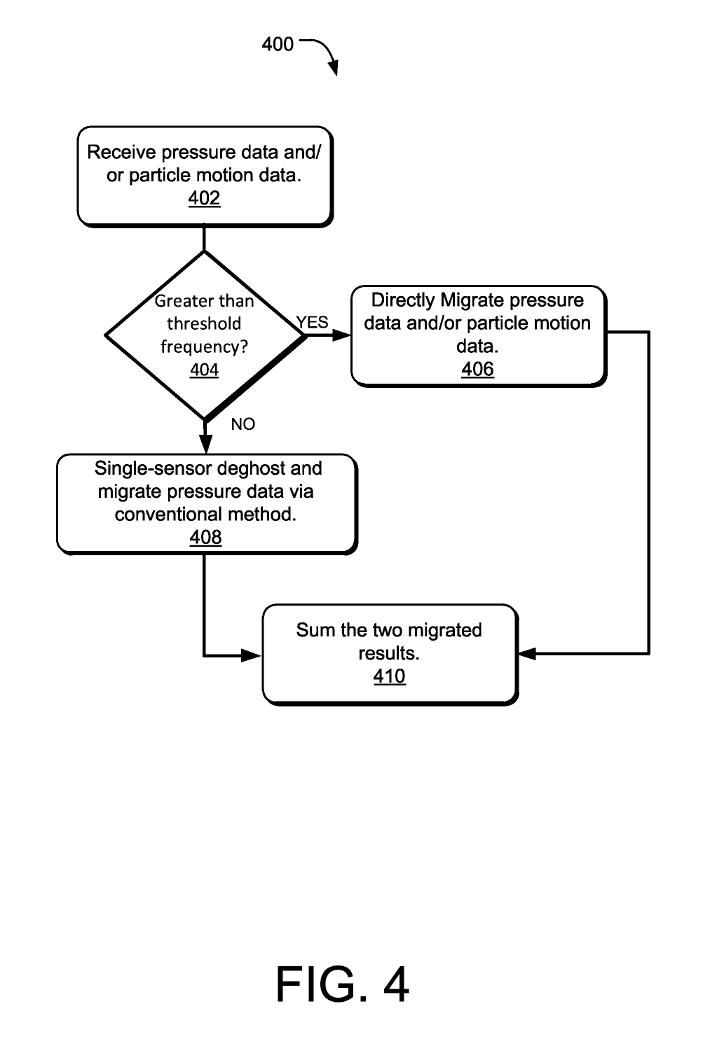

FIG. 4 shows an example process chart 400 illustrating an example embodiment for mitigating noise in acoustic vector imaging. In this embodiment, the optimal (or improved) weighting are directly obtained from the measured multi-component data. Furthermore, the optimal weighting may serve as a preconditioning filter and switches between conventional and vector acoustic imaging to provide the final image, which is a hybrid sum. The order in which the method is described is not intended to be construed as a limitation, and any number of the described method blocks can be combined in any order to implement the method, or alternate method; moreover, process 400 may be combined or supplemented with other appropriate techniques and methods for processing collected data. Additionally, individual blocks may be deleted from the method without departing from the spirit and scope of the subject matter described herein. Furthermore, the method may be implemented in any suitable hardware, software, firmware or a combination thereof, without departing from the scope of the invention (e.g., computing system 100 as illustrated in FIG. 1).

At block 402, receiving pressure data and particle motion data is performed. For example, similar to the FIG. 2 above, the hydrophone 108 measures the pressure wavefield while the multi-component seismic sensors 106 measures additional components such as a particle motion vector (e.g., acceleration or velocity).

At block 404, determining if a frequency of the pressure data is greater than a frequency threshold is performed. For example, the obtained pressure data includes a measured frequency at a particular point in time or space. In this example, if the measured frequency is greater than the frequency threshold, then at block 406, the frequencies of both pressure data and its gradient components are directly migrated with the vector acoustic imaging technique. This direct migration may not involve the optimal weight function as described in equation (9) above.

On the other hand, if the measured frequency is less than the frequency threshold, then at block 408, the low frequencies of the pressure data are single-sensor deghosted. The deghosted result is migrated via any conventional migration method. The frequency threshold may be configured to determine which migration technique is applied to the pressure data and/or various gradient component(s).

At block 410, summing of the two migrated results is performed. For example, the results of the direct migration for frequencies that are above the frequency threshold and the results of the conventional migration method for frequencies that are below the frequency threshold is added to lead to the final image. In this example, the hybrid approach is simpler and less sophisticated as compared to use of additional noise and optimal weighting as described above.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

What is claimed is:

1. A method of wavefield extrapolation, the method comprising:
receiving data representing at least one measurement of pressure wavefield or particle motion wavefield;
modeling the received data as a sum of signal and noise;
providing a noise model to components of the received data; and
weighting the measured components of the received data to reduce the impact of noise of results of the wavefield extrapolation.

2. The method as recited in claim 1, wherein the wavefield extrapolation includes seismic imaging.

3. The method as recited in claim 1, wherein the particle motion wavefield includes at least one directional component of the gradient of the pressure data.

4. The method as recited in claim 1, wherein the received data includes at least one directional component of a particle velocity vector.

5. The method as recited in claim 1, wherein the received data includes at least one directional component of a particle acceleration vector.

6. The method as recited in claim 1, wherein noise is a scalar for pressure and a vector for particle motion.

7. The method as recited in claim 1, wherein the weighting is determined based on generated noise and the received data.

8. The method as recited in claim 7, wherein the noise is generated based on assumed or estimated statistics of the noise.

9. The method as recited in claim 8, further comprising approximating simulated noise as part of the different noise models, to be stochastic processes that are spatially invariant with a source position or receiver position.

10. The method as recited in claim 1, wherein the weights act as scalars or vectors.

11. The method as recited in claim 1, wherein weighting is based on optimization methods that are carried out in different sub-domains of the wavefield extrapolation.

12. The method as recited in claim 11, wherein the optimization is dependent on one or more wavefield extrapolation subdomains.

13. The method as recited in claim 11, wherein the wavefield extrapolation subdomains include a source from a group comprising an image point, a shot, a receiver, and frequency.

14. The method as recited in claim 1, wherein the weighting is directly obtained from the received data, wherein the weighting is one or more of preconditioning filter or switches between conventional and wavefield extrapolation.

15. A method of mitigating noise in acoustic vector imaging comprising:
receiving pressure data or particle motion data;
determining if frequencies of components of the received pressure data or motion data is greater than threshold values; and
directly summing migrated frequencies of the received pressure data or motion data, if the frequencies are greater than the threshold values.

16. The method of claim 15, wherein frequencies of pressure data and gradients of pressure data are summed.

17. The method of claim 15, wherein, wherein frequencies that are not greater than related frequencies are deghosted.

18. The method of claim 17, wherein the frequencies that are deghosted are migrated and summed with other migrated frequencies.

19. The method of claim 15, further comprising adjusting the threshold values based on migration techniques applied to the pressure data or gradients of the pressure data.
